(19) United States
(12) Patent Application Publication
(10) Pub. No.: US 2026/0157605 A1
(43) Pub. Date: Jun. 11, 2026

(54) DRAIN RACK

(71) Applicant: Shenzhen Lute Jiacheng Supply Chain Management Co., Ltd., Shenzhen (CN)

(72) Inventors: Siyu LI, Shenzhen (CN); Qiao YAO, Shenzhen (CN); Liu LIU, Shenzhen (CN); Caihu JIA, Shenzhen (CN)

(73) Assignee: Shenzhen Lute Jiacheng Supply Chain Management Co., Ltd., Shenzhen (CN)

(21) Appl. No.: 18/989,681

(22) Filed: Dec. 20, 2024

(30) Foreign Application Priority Data
Dec. 6, 2024 (CN) 202423018142.9

(51) Int. Cl. A47L 19/04; F26B 25/18

(52) U.S. Cl. CPC A47L 19/04; F26B 25/18

(57) ABSTRACT

A drain rack includes a base and at least one back plate. Each back plate is provided with an installation surface and an outer peripheral surface provided around the installation surface, the installation surface is provided with at least one bottle rack, the outer peripheral surface is provided with a first connecting portion and a second connecting portion opposite to the first connecting portion and adapted to the first connecting portion; the second connecting portion is detachably matched with the first connecting portion; the bottle rack is provided between the first connecting portion and the second connecting portion; the base is provided with the first connecting portion, the first connecting portion on the base is detachably connected with the second connecting portion on the back plate.

### CROSS-REFERENCE TO RELATED APPLICATIONS

This application claims priority to Chinese Patent Application No. 202423018142.9, filed on December 6, 2024, the content of which is incorporated herein by reference in its entirety.

### TECHNICAL FIELD

The present application relates to the technical field of infant and toddler products, and in particular to a drain rack.

### BACKGROUND

The milk bottle after use needs to be cleaned immediately and dried quickly to prevent milk stains and mold growth, thus ensuring hygiene and safety. However, the common inverted drainage method easily makes the mouth of the milk bottle and the nipple directly contact the unclean desktop, thereby increasing the possibility of secondary contamination, especially the nipple connection is more susceptible to bacterial contamination. To solve this problem, a dedicated milk bottle drain rack is designed to provide a convenient and hygienic drainage solution.

In the related art, the milk bottle drain rack usually includes a base and a back plate, the base is connected to the back plate, and a plurality of bottle racks are provided on the back plate at intervals. The bottle rack can extend into the milk bottle to support the milk bottle, so that the water stains on the inner wall of the milk bottle can flow down naturally and be collected in the base, but the user cannot choose the number of back plates according to their needs, resulting in poor flexibility and convenience of the drain rack.

### SUMMARY

The main purpose of the present application is to propose a drain rack, which aims to improve the convenience and flexibility of the drain rack.

To achieve the above-mentioned purpose, the drain rack proposed by the present application includes: a base; and at least one back plate. Each back plate is provided with an installation surface and an outer peripheral surface provided around the installation surface, the installation surface is provided with at least one bottle rack, the outer peripheral surface is provided with a first connecting portion and a second connecting portion opposite to the first connecting portion and adapted to the first connecting portion; the second connecting portion is detachably matched with the first connecting portion; the bottle rack is provided between the first connecting portion and the second connecting portion; the base is provided with the first connecting portion, the first connecting portion on the base is detachably connected with the second connecting portion on the back plate.

In an embodiment, the outer peripheral surface is provided with a slot and a buckle opposite to the slot, the first connecting portion includes the slot, and the second connecting portion includes the buckle.

In an embodiment, the installation surface is provided with a plurality of fixing portions, one end of the bottle rack is provided with a matching portion, and each matching portion is detachably connected with one of the fixing portions.

In an embodiment, the installation surface is provided with a connecting hole, and an anti-drop hole is extended at one side of the connecting hole, and the connecting hole is communicated with the anti-drop hole to form the fixing portion; the matching portion includes a boss protruding from a side of the bottle rack facing the back plate, and the boss is provided with a first protruding segment and a second protruding segment stacked in sequence from the bottle rack to a direction away from the bottle rack, and a cross-sectional size of the first protruding segment is smaller than a cross-sectional size of the second protruding segment; the first protruding segment is adapted to the anti-drop hole, and the connecting hole is adapted to the second protruding segment, to cause the first protruding segment to slide from the connecting hole to the anti-drop hole during an installation stroke of the bottle rack, so that the bottle rack is fixed to the back plate.

In an embodiment, the base includes a body and a water receiving box, the body is provided with a water receiving groove with a notch, a side of the body facing the back plate is provided with a plurality of water leakage holes communicating with the water receiving groove, and the water receiving box is inserted into the water receiving groove.

In an embodiment, the side of the body facing the back plate is provided with a concave groove, a bottom wall of the concave groove is provided with a plurality of the water leakage holes; and/or an inner peripheral wall of each of the water leakage holes is formed with a guide slope.

In an embodiment, the drain rack includes a drain basket, the drain basket is provided with a first accommodating cavity, a bottom wall of the first accommodating cavity is provided with a plurality of first through holes, a side of the drain basket facing the back plate is provided with the second connecting portion, and the first connecting portion on the drain basket is detachably connected to the second connecting portion on the back plate.

In an embodiment, the drain basket includes a frame and a supporting portion, a side of the frame facing the back plate is provided with the second connecting portion, the frame is provided with the first accommodating cavity, the supporting portion is detachably sleeved at the frame, the supporting portion is provided with a second accommodating cavity, a bottom wall of the second accommodating cavity is provided with a plurality of second through holes, and each second through hole corresponds to one first through hole.

In an embodiment, the drain rack includes a milk bottle brush hanger and a water-receiving cup hanger, the milk bottle brush hanger is detachably provided on the drain basket or the back plate, the water-receiving cup hanger is detachably provided on the base or the back plate, and the water-receiving cup hanger corresponds to the milk bottle brush hanger.

In an embodiment, the drain rack includes a hook, and the hook is detachably provided on the drain basket or the back plate.

In the technical solution of the present application, the first connecting portion is detachably matched with the second connecting portion, so that the user can select the number of back plates (that is, the number of bottle racks) and assemble them according to their needs. When the number of bottle racks required is small, the user can use only one back plate, and when the number of bottle racks required is large, the user can connect and stack the plurality of back plates for use. When the drain rack needs to be carried out, the base and the back plate can be disassembled to save space for easy storage and carrying, which provides great convenience and flexibility for the user. Whether it is daily use at home or when traveling, it can meet the different needs of the user while maintaining the practicality and economy of the product.

### BRIEF DESCRIPTION OF THE DRAWINGS

In order to explain the embodiments of the present application or the technical solutions in the existing technology more clearly, the accompanying drawings needed to be used in the description of the embodiments or the existing technology will be briefly introduced below. Obviously, the accompanying drawings in the following description are only some embodiments of the present application, other accompanying drawings can be obtained based on the provided accompanying drawings without exerting creative efforts for those skilled in the art.

FIG. 1 is an exploded structural schematic diagram of a drain rack according to an embodiment of the present application.

FIG. 2 is a structural schematic diagram of a back plate according to an embodiment of the present application.

FIG. 3 is a structural schematic diagram of a bottle rack according to an embodiment of the present application.

FIG. 4 is a structural schematic diagram of a base according to an embodiment of the present application.

FIG. 5 is an exploded structural schematic diagram of a drain basket according to an embodiment of the present application.

The realization of the purpose, functional features and advantages of the present application will be further described in conjunction with the embodiments and with reference to the accompanying drawings.

### DETAILED DESCRIPTION OF THE EMBODIMENTS

The technical solutions in the embodiments according to the present application will be clearly and completely described below in conjunction with the accompanying drawings in the embodiments according to the present application, and it is clear that the described embodiments are only a part of the embodiments according to the present application, and not all of the embodiments. Based on the embodiments in the present application, all other embodiments obtained by those skilled in the art without making creative labor fall within the scope of the present application.

It should be noted that if there are directional instructions (such as up, down, left, right, front, back or the like) involved in the embodiments of the present application, the directional indications are only configured to explain the relative positional relationship, movement and so on between various components in a specific posture (as shown in the accompanying drawings). If the specific posture changes, the directional indication will also change accordingly.

In addition, if there are descriptions involving “first”, “second” or the like in the embodiments of the present application, the descriptions of “first”, “second” or the like are only for descriptive purposes and cannot be understood as indicating or implying the relative importance or implicitly indicating the quantity of the technical features indicated. Therefore, features defined as “first” and “second” may explicitly or implicitly include at least one of these features. In addition, if “and/or” appears in the text, it means that the three parallel solutions are included, taking “A and/or B” as an example, it includes solution A, or solution B, or a solution that satisfies both A and B at the same time. In addition, the technical solutions of various embodiments can be combined with each other, but it is based on that those skilled in the art can realize. When the combination of technical solutions is contradictory or cannot be realized, it should be considered that such combination of technical solutions does not exist and is not within the scope claimed by the present application.

The present application proposes a drain rack 100.

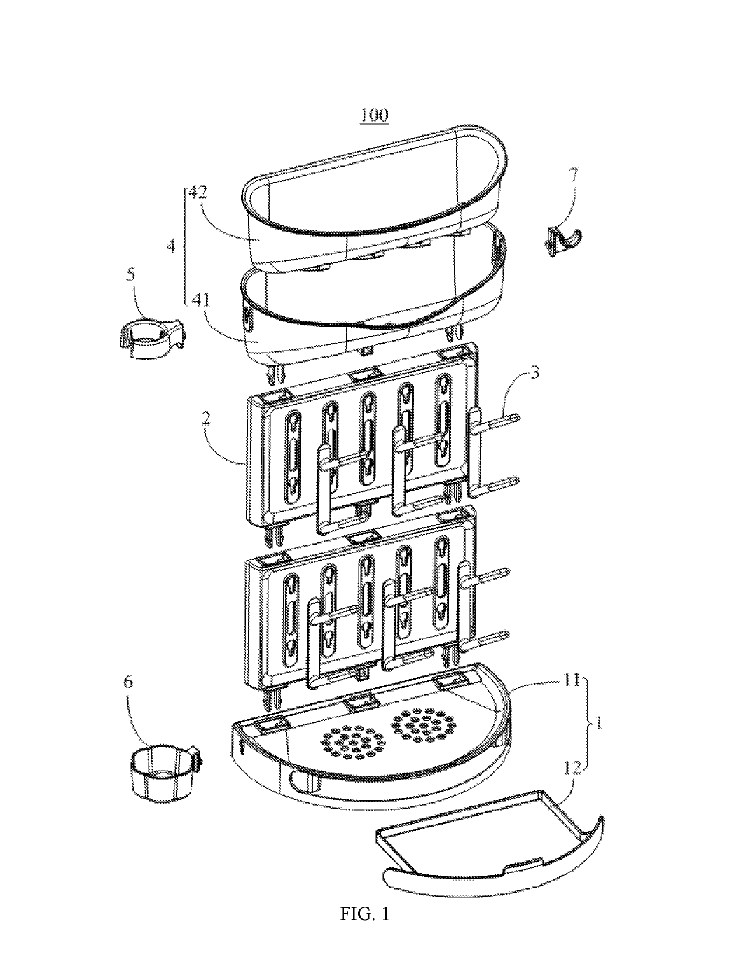

Referring to FIG. 1 to FIG. 5, in an embodiment of the present application, the drain rack 100 includes a base 1 and at least one back plate 2, each back plate 2 is provided with an installation surface 24 and an outer peripheral surface 25 provided around the installation surface 24, the installation surface 24 is provided with at least one bottle rack 3, the outer peripheral surface 25 is provided with a first connecting portion 21 and a second connecting portion 22 opposite to the first connecting portion 21 and adapted to the first connecting portion 21; the second connecting portion 22 is detachably matched with the first connecting portion 21; the bottle rack 3 is provided between the first connecting portion 21 and the second connecting portion 22; the base 1 is provided with the first connecting portion 21, the first connecting portion 21 on the base 1 is detachably connected with the second connecting portion 22 on the back plate 2.

In the technical solution of the present application, the first connecting portion 21 and the second connecting portion 22 are detachably matched, so that the user can select the number of back plates 2 (that is, the number of bottle racks 3) and assemble them according to their needs. When the number of bottle racks 3 required is small, the user can use only one back plate 2, and when the number of bottle racks 3 required is large, the user can connect and stack the plurality of back plates 2 for use. When the drain rack 100 needs to be carried out, the base 1 and the back plate 2 can be disassembled to save space for easy storage and carrying, which provides great convenience and flexibility for the user. Whether it is daily use at home or when traveling, it can meet the different needs of the user while maintaining the practicality and economy of the product. The first connecting portion 21 and the second connecting portion 22 are detachably matched, which can be a buckle 221 connection method or a screw connection method, and the present application does not limit this. When the plurality of back plates 2 are connected, the upper side of the back plate 2 and the lower side of the back plate 2 can be connected, or the left side of the back plate 2 and the right side of the back plate 2 can be connected, and the present application does not limit this.

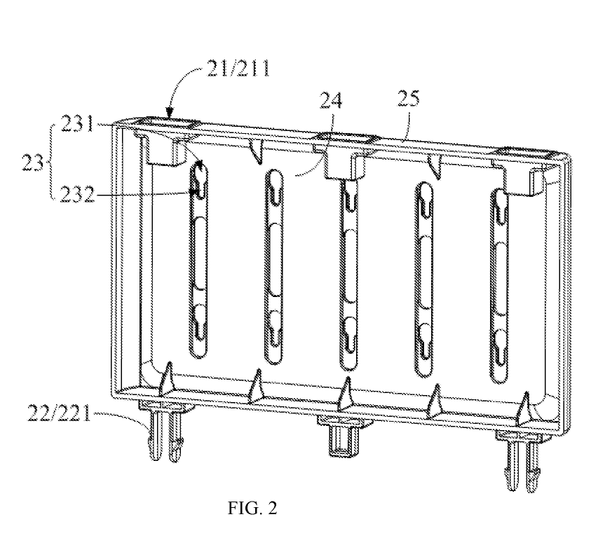

Specifically, referring to FIG. 2, in an embodiment of the present application, the outer peripheral surface 24 is provided with a slot 211 and a buckle 221 opposite to the slot 211, the first connecting portion 21 includes the slot 211, and the second connecting portion 22 includes the buckle 221. The outer peripheral surface 24 is provided with a slot 211 and a buckle 221 opposite to each other, the user can insert the buckle 221 of one back plate 2 into the slot 211 of another back plate 2 to achieve connection by simple operation, which allows the user to quickly assemble and disassemble the back plate 2 and provides great convenience. The cooperation between the slot 211 and the buckle 221 provides a stable connection to ensure that the back plate 2 will not loosen or fall off during use, thereby improving the safety and reliability of the product. The user can freely add or remove the back plate 2 as needed and flexibly adjust the capacity and structure of the drain rack 100 to adapt to different usage scenarios. Due to the design of the slot 211 and the buckle 221, the connecting portion is less worn and can maintain a longer service life.

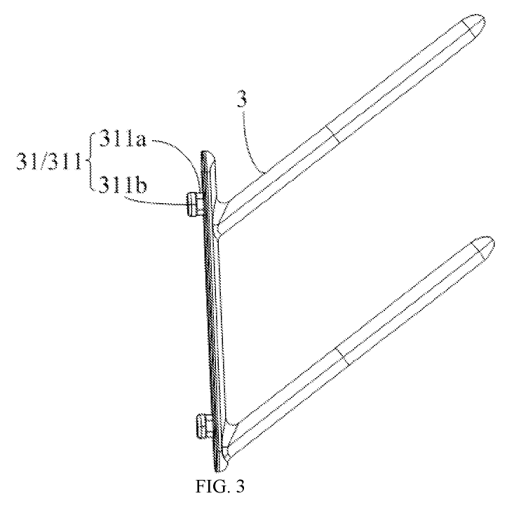

In order to realize free selection of the number of bottle racks 3, referring to FIG. 2 and FIG. 3, in an embodiment of the present application, the installation surface 24 is provided with a plurality of fixing portions 23, one end of the bottle rack 3 is provided with a matching portion 31, and each matching portion 31 is detachably connected with one of the fixing portions 23. The connection between each matching portion 31 and the corresponding fixing portion 23 is detachable, and the user can easily install or remove the bottle rack 3 as needed, and can adjust the number of the bottle rack 3 and the position of the bottle rack 3 according to actual needs, thereby improving the flexibility of use. Since the bottle rack 3 is detachable, the user can detach the bottle rack 3 to adjust the spacing of the bottle rack 3 independently to meet the needs of different milk bottle sizes and scenarios. The detachable bottle rack 3 makes cleaning and maintenance easier, and the user can clean each bottle rack 3 separately without disassembling the entire drain rack 100. When the drain rack 100 needs to be stored or carried, the user can disassemble the bottle rack 3 to reduce the occupied space, which is convenient for carrying and storage. The matching portion 31 and the fixing portion 23 can be a snap-in hole and a snap-in protrusion, or can be a slot 211 and a buckle 221, and the present application does not limit this.

More specifically, referring to FIG. 2 and FIG. 3, in an embodiment of the present application, the installation surface 24 is provided with a connecting hole 231, and an anti-drop hole 232 is extended at one side of the connecting hole 231, and the connecting hole 231 is communicated with the anti-drop hole 232 to form the fixing portion 23; the matching portion 31 includes a boss 311 protruding from a side of the bottle rack 3 facing the back plate 2, and the boss 311 is provided with a first protruding segment 311a and a second protruding segment 311b stacked in sequence from the bottle rack 3 to a direction away from the bottle rack 3, and a cross-sectional size of the first protruding segment 311a is smaller than a cross-sectional size of the second protruding segment 311b; the first protruding segment 311a is adapted to the anti-drop hole 232, and the connecting hole 231 is adapted to the second protruding segment 311b, to cause the first protruding segment 311a to slide from the connecting hole 231 to the anti-drop hole 232 during an installation stroke of the bottle rack 3, so that the bottle rack 3 is fixed to the back plate 2. When the bottle rack 3 is removed from the back plate 2, the first protruding segment 311a slides from the anti-drop hole 232 to the connecting hole 231, at that time, the first protruding segment 311a and the second protruding segment 311b can be separated from the back plate 2 by the connecting hole 231, so that the bottle rack 3 is removed from the back plate 2. When the bottle rack 3 is installed on the back plate 2, the first protruding segment 311a and the second protruding segment 311b pass through the connecting hole 231, and the first protruding segment 311a slides from the connecting hole 231 to the anti-drop hole 232. Since the second protruding segment 311b cannot be separated from the anti-drop hole 232, the bottle rack 3 is fixed to the back plate 2. It should be noted that there is no limitation on the number of the first protruding segment 311a, the number of the second protruding segment 311b, the number of the corresponding connecting hole 231 and the number of the anti-drop hole 232, and they can be one or more.

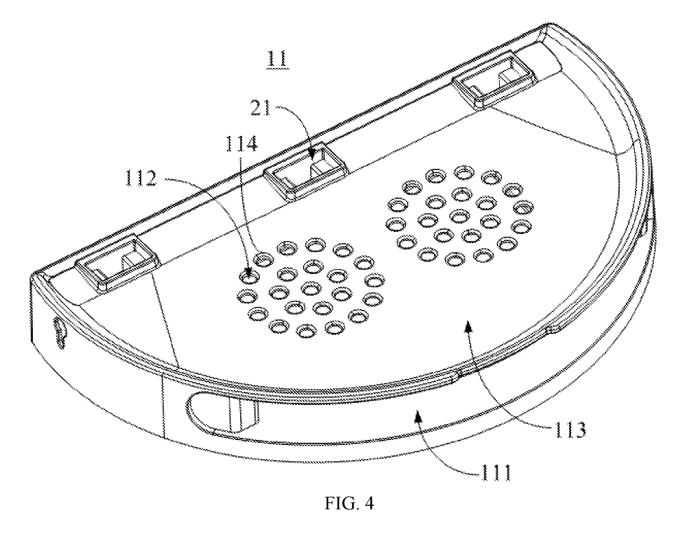

To facilitate the collection of water drops dripping from a milk bottle, referring to FIG. 1 and FIG. 4, in an embodiment of the present application, the base 1 includes a body 11 and a water receiving box 12, the body 11 is provided with a water receiving groove 111 with a notch, a side of the body 11 facing the back plate 2 is provided with a plurality of water leakage holes 112 communicating with the water receiving groove 111, and the water receiving box 12 is inserted into the water receiving groove 111. The base 1 includes a body 11 and a water receiving box 12. The body 11 is provided with a water receiving groove 111. The water receiving box 12 is inserted into the water receiving groove 111 via a notch of the water receiving groove 111. The bottle rack 3 can be extended into the milk bottle to support the milk bottle, so that water stains on the inner wall of the milk bottle can flow down naturally and flow into the water receiving box 12 via the water leakage hole 112. The water receiving box 12 is configured to actually receive water drops dripping from the water leakage hole 112 to prevent the water drops from directly dripping onto the ground or the operating table, thereby ensuring that the water drops dripping from the milk bottle can be effectively collected, avoiding water drops from splashing everywhere, and keeping the use environment clean. The water receiving box 12 can be easily taken out for cleaning and maintenance, and the user can regularly empty the water receiving box 12 according to the amount of water collected, which is convenient and quick, with a simple and practical structure. The water leakage hole 112 can be circular or in other shapes, and the arrangement of the plurality of water leakage holes 112 can be in a circular ring or in other arrangements, which is not limited by the present application.

Furthermore, referring to FIG. 1 and FIG. 4, in an embodiment of the present application, the side of the body 11 facing the back plate 2 is provided with a concave groove 113, a bottom wall of the concave groove 113 is provided with a plurality of the water leakage holes 112. The design of the concave groove 113 allows water droplets to flow along the groove body and eventually drip into the water receiving box 12 via the water leakage hole 112, effectively preventing water droplets from splashing everywhere. The design of the concave groove 113 helps control the direction of water flow, thus reducing the impact of water droplets on the surrounding environment, and keeping the operating area dry and clean. By matching the concave groove 113 with the water leakage hole 112, the structure of the base 1 is more compact and the efficiency of collecting water droplets is improved.

To improve the drainage efficiency, referring to FIG. 1 and FIG. 4, in an embodiment of the present application, an inner peripheral wall of each of the water leakage holes 112 is formed with a guide slope 114. The inner wall of the water leakage hole 112 is designed with a guide slope 114, which helps to guide the water flow to flow in a specific direction. The guide slope 114 can speed up the water flow and reduce the stagnation of water droplets in the water leakage hole 112, thereby improving the overall drainage efficiency. Guided by the guide slope 114, the water droplets flow into the water receiving box 12 more smoothly, reducing the splashing and noise of the water droplets during the outflow process. The design of the guide slope 114 simplifies the cleaning process, reduces the accumulation of scale and impurities in the water leakage hole 112, and facilitates maintenance.

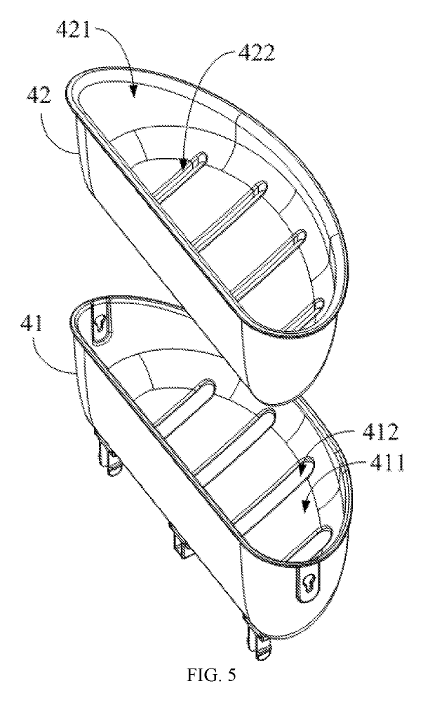

Furthermore, referring to FIG. 1 and FIG. 5, in an embodiment of the present application, the drain rack 100 includes a drain basket 4, the drain basket 4 is provided with a first accommodating cavity 411, a bottom wall of the first accommodating cavity 411 is provided with a plurality of first through holes 412, a side of the drain basket 4 facing the back plate 2 is provided with the second connecting portion 22, and the first connecting portion 21 on the drain basket 4 is detachably connected to the second connecting portion 22 on the back plate 2. The drain basket 4 is an important part of the drain rack 100, and is configured to place objects that need to be drained, such as pacifiers, tableware, etc. The drain basket 4 is provided with a first accommodating cavity 411 inside, which is configured to accommodate objects. The bottom wall of the first accommodating cavity 411 is provided with a plurality of first through holes 412, and the first through holes 412 allow water droplets to flow out of the drain basket 4 to achieve the drainage function. The side of the drain basket 4 facing the back plate 2 is provided with a second connecting portion 22, so that the drain basket 4 can be flexibly connected to the back plate 2 or other components, which is convenient for assembly and use, and allows users to easily disassemble and clean, and keep the equipment hygienic. The drain basket 4 can be connected to the upper side of the back plate 2, or can be connected to the left side of the back plate 2 and the right side of the back plate 2, and the present application does not limit this.

Referring to FIG. 1 and FIG. 5, in an embodiment of the present application, the drain basket 4 includes a frame 41 and a supporting portion 42, a side of the frame 41 facing the back plate 2 is provided with the second connecting portion 22, the frame 41 is provided with the first accommodating cavity 411, the supporting portion 42 is detachably sleeved at the frame 41, the supporting portion 42 is provided with a second accommodating cavity 421, a bottom wall of the second accommodating cavity 421 is provided with a plurality of second through holes 421, and each second through hole 421 corresponds to one first through hole 412. The supporting portion 42 is configured for placing objects that need to be drained, such as pacifiers, tableware, etc. Water drops flow out from the first through hole 412 and the second through hole 421 to achieve a drainage function. The double-layer structure of the supporting portion 42 and the frame 41 provides a more efficient drainage effect. Water drops can be smoothly discharged by the two-layer structure. The detachable design of the supporting portion 42 makes cleaning and maintenance easier. The user can easily disassemble the supporting portion 42 for cleaning, and the user can also adjust it according to different usage requirements. The supporting portion 42 can be used alone or in combination with the frame 41.

To facilitate the collection of milk bottle brushes, referring to FIG. 1, in an embodiment of the present application, the drain rack 100 includes a milk bottle brush hanger 5 and a water-receiving cup hanger 6, the milk bottle brush hanger 5 is detachably provided on the drain basket 4 or the back plate 2, the water-receiving cup hanger 6 is detachably provided on the base 1 or the back plate 2, and the water-receiving cup hanger 6 corresponds to the milk bottle brush hanger 5. The milk bottle brush hanger 5 and the water-receiving cup hanger 6 provide additional storage and draining functions. The milk bottle brush hanger 5 can be detachably provided on the drain basket 4 or the back plate 2, providing flexibility in the installation position. The water-receiving cup hanger 6 can also be detachably provided on the base 1 or the back plate 2, allowing the user to select the position of the hanger according to needs. The water-receiving cup hanger 6 corresponds to the milk bottle brush hanger 5, so that water dripping from the milk bottle brush on the milk bottle brush hanger 5 falls into the water-receiving cup on the water-receiving cup hanger 6, preventing water drops from directly dripping onto the ground or the operating table, ensuring that water drops dripping from the milk bottle brush can be effectively collected, avoiding water drops from splashing everywhere, and keeping the use environment clean. The milk bottle brush hanger 5 and the water-receiving cup hanger can be detachably provided on the drain basket 4 or the back plate 2, and can adopt the fixing portion 23 and the matching portion 31 in the above embodiment, or can adopt the first connecting portion 21 and the second connecting portion 22 in the above embodiment, and the present application does not limit this. By providing a special hanger, the drain rack 100 can make more effective use of space and accommodate a milk bottle brush and a water-receiving cup at the same time. The special hanger helps to keep the drain rack 100 neat and orderly, avoiding the confusion caused by the random placement of the milk bottle brush and the water-receiving cup. Since the hanger is detachable, the user can easily remove the hanger for cleaning and maintain the hygiene of the drain rack 100.

Referring to FIG. 1, in an embodiment of the present application, the drain rack 100 includes a hook 7, and the hook 7 is detachably provided on the drain basket 4 or the back plate 2. The hook 7 can be detachably provided on the drain basket 4 or the back plate 2, and can adopt the fixing portion 23 and the matching portion 31 in the above embodiment, or can adopt the first connecting portion 21 and the second connecting portion 22 in the above embodiment, and the present application does not limit this. The design of the hook 7 enables the drain rack 100 to not only place items, but also hang small objects such as towels, brushes, cups, etc. that need to be drained, and the hook 7 can be detachably installed on the drain basket 4 or the back plate 2, providing flexibility in the installation position. The hook 7 provides additional storage space, making the drain rack 100 can make more effective use of vertical space. Users can conveniently hang and take items according to their needs, thus improving the convenience of use. The hook 7 helps to keep the drain rack 100 neat and orderly, avoiding the chaos caused by random placement of items.

The above are only some exemplary implementations of the present application, and are not intended to limit the scope of the present application. Under the concept of the present application, any equivalent structure transformation made by using the description and accompanying drawings of the present application, or directly or indirectly applied in other related technical fields, is included within the scope of the present application.

What is claimed is:

1. A drain rack, comprising:
a base; and
at least one back plate, wherein:
each back plate is provided with an installation surface and an outer peripheral surface provided around the installation surface, the installation surface is provided with at least one bottle rack, the outer peripheral surface is provided with a first connecting portion and a second connecting portion opposite to the first connecting portion and adapted to the first connecting portion;
the second connecting portion is detachably matched with the first connecting portion;
the bottle rack is provided between the first connecting portion and the second connecting portion; and
the base is provided with the first connecting portion, and the first connecting portion on the base is detachably connected with the second connecting portion on the back plate.

2. The drain rack according to claim 1, wherein the outer peripheral surface is provided with a slot and a buckle opposite to the slot, the first connecting portion comprises the slot, and the second connecting portion comprises the buckle.

3. The drain rack according to claim 1, wherein the installation surface is provided with a plurality of fixing portions, one end of the bottle rack is provided with a matching portion, and each matching portion is detachably connected with one of the fixing portions.

4. The drain rack according to claim 3, wherein:
the installation surface is provided with a connecting hole, and an anti-drop hole is extended at one side of the connecting hole, and the connecting hole is communicated with the anti-drop hole to form the fixing portion;
the matching portion comprises a boss protruding from a side of the bottle rack facing the back plate, and the boss is provided with a first protruding segment and a second protruding segment stacked in sequence from the bottle rack to a direction away from the bottle rack, and a cross-sectional size of the first protruding segment is smaller than a cross-sectional size of the second protruding segment; and
the first protruding segment is adapted to the anti-drop hole, and the connecting hole is adapted to the second protruding segment, to cause the first protruding segment to slide from the connecting hole to the anti-drop hole during an installation stroke of the bottle rack, so that the bottle rack is fixed to the back plate.

5. The drain rack according to claim 1, wherein the base comprises a body and a water receiving box, the body is provided with a water receiving groove with a notch, a side of the body facing the back plate is provided with a plurality of water leakage holes communicating with the water receiving groove, and the water receiving box is inserted into the water receiving groove.

6. The drain rack according to claim 5, wherein:
the side of the body facing the back plate is provided with a concave groove, a bottom wall of the concave groove is provided with a plurality of the water leakage holes; and/or
an inner peripheral wall of each of the water leakage holes is formed with a guide slope.

7. The drain rack according to claim 1, wherein the drain rack further comprises a drain basket, the drain basket is provided with a first accommodating cavity, a bottom wall of the first accommodating cavity is provided with a plurality of first through holes, a side of the drain basket facing the back plate is provided with the second connecting portion, and the first connecting portion on the drain basket is detachably connected to the second connecting portion on the back plate.

8. The drain rack according to claim 7, wherein the drain basket comprises a frame and a supporting portion, a side of the frame facing the back plate is provided with the second connecting portion, the frame is provided with the first accommodating cavity, the supporting portion is detachably sleeved at the frame, the supporting portion is provided with a second accommodating cavity, a bottom wall of the second accommodating cavity is provided with a plurality of second through holes, and each second through hole corresponds to one first through hole.

9. The drain rack according to claim 7, wherein the drain rack further comprises a milk bottle brush hanger and a water-receiving cup hanger, the milk bottle brush hanger is detachably provided on the drain basket or the back plate, the water-receiving cup hanger is detachably provided on the base or the back plate, and the water-receiving cup hanger corresponds to the milk bottle brush hanger.

10. The drain rack according to claim 7, wherein the drain rack further comprises a hook, and the hook is detachably provided on the drain basket or the back plate.
